(19) United States
(12) Patent Application Publication
(10) Pub. No.: US 2024/0193460 A1
(43) Pub. Date: Jun. 13, 2024

(54) DATA PROCESSING METHOD AND DATA PROCESSING APPARATUS

(71) Applicants: Beijing Zhongxiangying Technology Co., Ltd., Beijing (CN); BOE TECHNOLOGY GROUP CO., LTD., Beijing (CN)

(72) Inventors: Yu WANG, Beijing (CN); Chuan WANG, Beijing (CN); Haijin WANG, Beijing (CN); Wangqiang HE, Beijing (CN); Dong CHAI, Beijing (CN); Jianmin WU, Beijing (CN); Yiming LEI, Beijing (CN); Hong WANG, Beijing (CN)

(21) Appl. No.: 17/908,478

(22) PCT Filed: May 31, 2021
(86) PCT No.: PCT/CN2021/097480

§ 371 Date: Aug. 31, 2022

(51) Int. Cl. G06N 20/00

(52) U.S. Cl. CPC G06N 20/00

(57) ABSTRACT

A data processing method, includes: obtaining sample data in response to a user's input operation on a graphical interface, the sample data including characteristic data and detection data of samples; displaying a sample distribution diagram on the graphical interface based on the sample data; obtaining a focus threshold used for classifying positive and negative samples, the focus threshold being determined based on the detection data of the samples; displaying a mark of the focus threshold in the sample distribution diagram on the graphical interface; distinguishing data display effects of the positive and negative samples based on the focus threshold; and determining a cause of abnormality of the samples based on the positive and negative samples.

### CROSS-REFERENCE TO RELATED APPLICATION

This application is a national phase entry under 35 USC 371 of International Patent Application No. PCT/CN2021/097480, filed on May 31, 2021, which is incorporated herein by reference in its entirety.

### TECHNICAL FIELD

The present disclosure relates to the field of data processing, and in particular, to a data processing method and a data processing apparatus.

### BACKGROUND

In a process of data analysis, it is generally needed to preprocess sample data and mark a sample distribution, so that efficiency and accuracy of the analysis may be improved during subsequent sample feature analysis or training of a machine learning model.

### SUMMARY

In one aspect, a data processing method is provided. The data processing method, includes: firstly, obtaining sample data in response to a user's input operation on a graphical interface, the sample data including characteristic data and detection data of samples; then, displaying a sample distribution diagram on the graphical interface based on the sample data; thereafter, obtaining a focus threshold used for classifying positive and negative samples, the focus threshold being determined based on the detection data of the samples; displaying a mark of the focus threshold in the sample distribution diagram on the graphical interface; distinguishing data display effects of the positive and negative samples based on the focus threshold; and finally, determining a cause of abnormality of the samples based on the positive and negative samples.

In some embodiments, the focus threshold includes at least one first focus threshold. Obtaining the focus threshold used for classifying the positive and negative samples, displaying the mark of the focus threshold in the sample distribution diagram on the graphical interface, and distinguishing the data display effects of the positive and negative samples based on the focus threshold, includes: receiving a user's setting operation of the at least one first focus threshold, displaying at least one mark of the at least one first focus threshold in the sample distribution diagram on the graphical interface; and distinguishing the data display effects of the positive and negative samples based on the at least one first focus threshold.

In some other embodiments, the at least one first focus threshold includes a first value. Distinguishing the data display effects of the positive and negative samples based on the at least one first focus threshold, includes: distinguishing the data display effects of the positive and negative samples based on a relationship between magnitudes of the detection data of the samples and a magnitude of the first value.

In some other embodiments, the at least one first focus threshold includes a second value and a third value, and the second value is less than the third value. Distinguishing the data display effects of the positive and negative samples based on the at least one first focus threshold, includes: distinguishing the data display effects of the positive and negative samples based on whether detection data of a sample in the samples is greater than the second value and less than the third value.

In some other embodiments, the focus threshold includes a second focus threshold, and the number of the samples is N. Obtaining the focus threshold used for classifying the positive and negative samples, displaying the mark of the focus threshold in the sample distribution diagram on the graphical interface, and distinguishing the data display effects of the positive and negative samples based on the focus threshold, includes: arranging detection data of N samples in an ascending order, and using a median or a mean of the detection data of the N samples as a reference focus value; determining the second focus threshold based on the reference focus value and the detection data of the N samples; and displaying a mark of the second focus threshold in the sample distribution diagram on the graphical interface, and distinguishing the data display effects of the positive and negative samples based on the second focus threshold.

In some other embodiments, determining the second focus threshold based on the reference focus value and the detection data of the N samples includes: in step a, averaging detection data, less than or equal to the reference focus value, of the detection data of the N samples to obtain a first mean; and averaging detection data, greater than the reference focus value, of the detection data of the N samples to obtain a second mean; in step b, making a difference between each of the detection data of the N samples that are arranged in sequence and the first mean one by one, and taking an absolute value of each difference to obtain a first mean difference DiffLowerMean DiffLowerMean=[l₁,l₂,l₃ . . . ,lᵢ . . . ,l_{N}]; making a difference between each of the detection data of the N samples that are arranged in sequence and the second mean one by one, and taking an absolute value of each difference to obtain a second mean difference DiffUpperMean, DiffUpperMean=[u₁,u₂,u₃ . . . uᵢ . . . u_{N}]; comparing each element in the first mean difference and a respective element in the second mean difference one by one, and determining a number k of which lᵢ is less than uᵢ(lᵢ<uᵢ), where i=1,2,3, . . . , N; and updating a reference focus index to k, and updating the reference focus value to a value of k-th detection data in the detection data of the N samples arranged in sequence; and in step c, repeating the step a and the step b until a value of the reference focus index does not change before and after an update; and determining the second focus threshold based on detection data corresponding to the reference focus index in the detection data of the N samples arranged in sequence.

In some other embodiments, the method further includes: screening the sample data based on a user's filtering operation of at least one filtering threshold; and displaying a distribution diagram of screened samples on the graphical interface.

In some other embodiments, the at least one filtering threshold includes at least one of an abnormal ratio threshold, an arrival ratio threshold, a production equipment threshold, an environmental parameter threshold, a detection time threshold or a generation time threshold.

In some other embodiments, the filtering operation includes a setting operation or a selecting operation.

In some other embodiments, the characteristic data of the samples includes at least one of a product model, a detection site, an abnormal type, an arrival ratio, a production equipment, an environmental parameter, detection time or generation time. The samples each include a plurality of sub-samples; the arrival ratio is used to indicate a proportion of a number of sub-samples actually detected in each sample to the total number of sub-samples included in the sample.

In some other embodiments, the detection data of the samples includes at least one of an abnormal ratio or a measurement parameter. The samples each include the plurality of sub-samples; the abnormal ratio is used to indicate a proportion of a number of abnormal sub-samples in each sample to a total number of sub-samples included in the sample.

In another aspect, a data processing method is provided. The data processing method includes: firstly, obtaining sample data, the sample data including characteristic data and detection data of samples; then, determining a focus threshold based on the detection data of the samples; thereafter, classifying the samples into positive and negative samples based on the focus threshold; and finally, determining a cause of abnormality of the samples based on the positive and negative samples.

In some embodiments, the focus threshold includes a second focus threshold, and the number of samples is N. Determining the focus threshold based on the detection data of the samples, includes: arranging detection data of N samples in an ascending order; using a median or a mean of the detection data of the N samples as a reference focus value; and determining the second focus threshold based on the reference focus value and the detection data of the N samples.

In some other embodiments, determining the second focus threshold based on the reference focus value and the detection data of the N samples includes: in step a, averaging detection data, less than or equal to the reference focus value, of the detection data of the N samples to obtain a first mean; and averaging detection data, greater than the reference focus value, of the detection data of the N samples to obtain a second mean; in step b, making a difference between each of the detection data of the N samples that are arranged in sequence and the first mean one by one, and taking an absolute value of each difference to obtain a first mean difference DiffLowerMean DiffLowerMean=[l₁,l₂,l₃ . . . ,lᵢ . . . ,l_{N}]; making a difference between each of the detection data of the N samples that are arranged in sequence and the second mean one by one, and taking an absolute value of each difference to obtain a second mean difference DiffUpperMean, DiffUpperMean=[u₁,u₂,u₃ . . . ,uᵢ . . . ,u_{N}]; comparing each element in the first mean difference and a respective element in the second mean difference one by one, and determining a number k of which lᵢ is less than uᵢ(lᵢ<uᵢ), where i=1,2,3, . . . ,N; and updating a reference focus index to k, and updating the reference focus value to a value of k-th detection data in the detection data of the N samples arranged in sequence; and in step c, repeating the step a and the step b until a value of the reference focus index does not change before and after an update; and determining the second focus threshold based on detection data corresponding to the reference focus index in the detection data of the N samples arranged in sequence.

In some other embodiments, the method further includes: screening the sample data based on at least one filtering threshold.

In some other embodiments, the at least one filtering threshold includes at least one of an abnormal ratio threshold, an arrival ratio threshold, a production equipment threshold, an environmental parameter threshold, a detection time threshold or a generation time threshold.

In some other embodiments, the characteristic data of the samples includes at least one of a product model, a detection site, an abnormal type, an arrival ratio, a production equipment, an environmental parameter, detection time or generation time. The samples each include a plurality of sub-samples; the arrival ratio is used to indicate a proportion of a number of sub-samples actually detected in each sample to the total number of sub-samples included in the sample.

In some other embodiments, the detection data of the samples includes at least one of an abnormal ratio or a measurement parameter. The samples each include the plurality of sub-samples; the abnormal ratio is used to indicate a proportion of a number of abnormal sub-samples in each sample to a total number of sub-samples included in the sample.

In yet another aspect, a data processing apparatus is provided. The data processing apparatus includes a memory and a processor. The memory is coupled to the processor. The memory is used to store computer program codes, and the computer program codes include computer instructions. When executing the computer instructions, the processor causes the data processing apparatus to perform one or more steps of the data processing method as described in any one of the above embodiments.

In yet another aspect, a non-transitory computer-readable storage medium is provided. The non-transitory computer-readable storage medium has stored thereon computer program instructions. When run on a processor, the computer program instructions cause the processor to perform one or more steps of the data processing method as described in any one of the above embodiments.

In yet another aspect, a computer program product is provided. The computer program product includes computer program instructions. When executed on a computer, the computer program instructions cause the computer to perform one or more steps of the data processing method as described in any of the above embodiments.

### BRIEF DESCRIPTION OF THE DRAWINGS

In order to describe technical solutions in the present disclosure more clearly, accompanying drawings to be used in some embodiments of the present disclosure will be introduced briefly below. Obviously, the accompanying drawings to be described below are merely accompanying drawings of some embodiments of the present disclosure, and a person of ordinary skill in the art can obtain other drawings according to these drawings. In addition, the accompanying drawings in the following description may be regarded as schematic diagrams, and are not limitations on actual sizes of products, actual processes of methods and actual timings of signals involved in the embodiments of the present disclosure.

FIG. 1 is a structural diagram of a data processing apparatus, in accordance with some embodiments;

FIG. 2 is a flow diagram of a data processing method, in accordance with some embodiments;

FIG. 3 is a diagram showing a display effect of a data processing method, in accordance with some embodiments;

FIG. 4 is a diagram showing another display effect of a data processing method, in accordance with some embodiments;

FIG. 5 is a flow diagram of another data processing method, in accordance with some embodiments;

FIG. 6 is a diagram showing yet another display effect of a data processing method, in accordance with some embodiments;

FIG. 7 is a flow diagram of yet another data processing method, in accordance with some embodiments;

FIG. 8 is a diagram showing yet another display effect of a data processing method, in accordance with some embodiments;

FIG. 9 is a diagram showing yet another display effect of a data processing method, in accordance with some embodiments;

FIG. 10 is a diagram showing yet another display effect of a data processing method, in accordance with some embodiments;

FIG. 11 is a flow diagram of yet another data processing method, in accordance with some embodiments;

FIG. 12 is a flow diagram of yet another data processing method, in accordance with some embodiments;

FIG. 13 is a flow diagram of yet another data processing method, in accordance with some embodiments;

FIG. 14 is a structural diagram of another data processing apparatus, in accordance with some embodiments;

FIG. 15 is a structural diagram of yet another data processing apparatus, in accordance with some embodiments;

FIG. 16 is a structural diagram of yet another data processing apparatus, in accordance with some embodiments; and

FIG. 17 is a structural diagram of yet another data processing apparatus, in accordance with some embodiments.

### DETAILED DESCRIPTION

Technical solutions in some embodiments of the present disclosure will be described clearly and completely with reference to the accompanying drawings below. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as an open and inclusive meaning, i.e., “including, but not limited to”. In the description of the specification, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

Hereinafter, the terms “first” and “second” are used for descriptive purposes only, and are not to be construed as indicating or implying the relative importance or implicitly indicating the number of indicated technical features. Thus, a feature defined with “first” or “second” may explicitly or implicitly include one or more of the features. In the description of the embodiments of the present disclosure, the term “a plurality of or the plurality of” means two or more unless otherwise specified.

In the description of some embodiments, terms such as “coupled” and “connected” and derivatives thereof may be used. For example, the term “connected” may be used in the description of some embodiments to indicate that two or more components are in direct physical or electrical contact with each other. For another example, the term “coupled” may be used in the description of some embodiments to indicate that two or more components are in direct physical or electrical contact. However, the term “coupled” or “communicatively coupled” may also mean that two or more components are not in direct contact with each other, but still cooperate or interact with each other. The embodiments disclosed herein are not necessarily limited to the contents herein.

The phrase “at least one of A, B and C” has the same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

As used herein, the term “if” is optionally construed as “when” or “in a case where” or “in response to determining that” or “in response to detecting”, depending on the context. Similarly, depending on the context, the phrase “if it is determined that” or “if [a stated condition or event] is detected” is optionally construed as “in a case where it is determined that”, “in response to determining that”, “in a case where [the stated condition or event] is detected” or “in response to detecting [the stated condition or event]”.

The phrase “applicable to” or “configured to” as used herein indicates an open and inclusive expression, which does not exclude devices that are applicable to or configured to perform additional tasks or steps.

In addition, the phrase “based on” or “according to” as used herein is meant to be open and inclusive, since a process, a step, a calculation or other action that is “based on” or “according to” one or more of the stated conditions or values may, in practice, be based on additional conditions or values beyond those stated.

At present, in the fields of semiconductors and panels, due to influences of production process, production equipment and other factors, manufactured products may have various defects. In order to meet increasing production demands and improve a yield of the products, it is necessary to analyze reasons why the defective products have these defects.

In a process of data analysis, it is generally needed to preprocess sample data and mark a sample distribution, so that efficiency and accuracy of the analysis may be improved during subsequent sample feature analysis or training of a machine learning model.

In general, when the sample data is analyzed, a cause of abnormality is positioned by mainly relying on human. Thus, time efficiency and accuracy of processing are extremely limited, and it is difficult to meet the increasing production demands. In order to improve the efficiency and the accuracy of the data analysis, the cause of abnormality may be determined by the machine learning algorithm. However, when the machine learning algorithm is used to analyze the cause of abnormality, if all of samples are analyzed regardless of an abnormal ratio of the samples, an amount of data may be too large, which will affect an operating efficiency of the machine learning algorithm. In addition, if there are a large number of samples with the particularly low abnormal ratio, the accuracy of analysis of the cause of abnormality may be affected.

In order to improve the accuracy of the data analysis, the embodiments of the present disclosure provide a data processing method. With this method, in a process of performing the data analysis, a distribution of sample data is visually displayed on a graphical interface, the sample data is screened by setting a threshold, and the data analysis is more accurate by reasonably classifying positive and negative samples.

The data processing method provided in the embodiments of the present disclosure may be applied to a universal data analysis platform (e.g., a machine learning platform) or a data analysis platform for a specific scene (e.g., a production data analysis system).

An execution subject of the data processing method provided in the embodiments of the present disclosure is a data processing apparatus. The data processing apparatus may be a terminal device or a server, a specific form of the data processing apparatus is not particularly limited in the embodiments of the present disclosure, and the above is only an exemplary description.

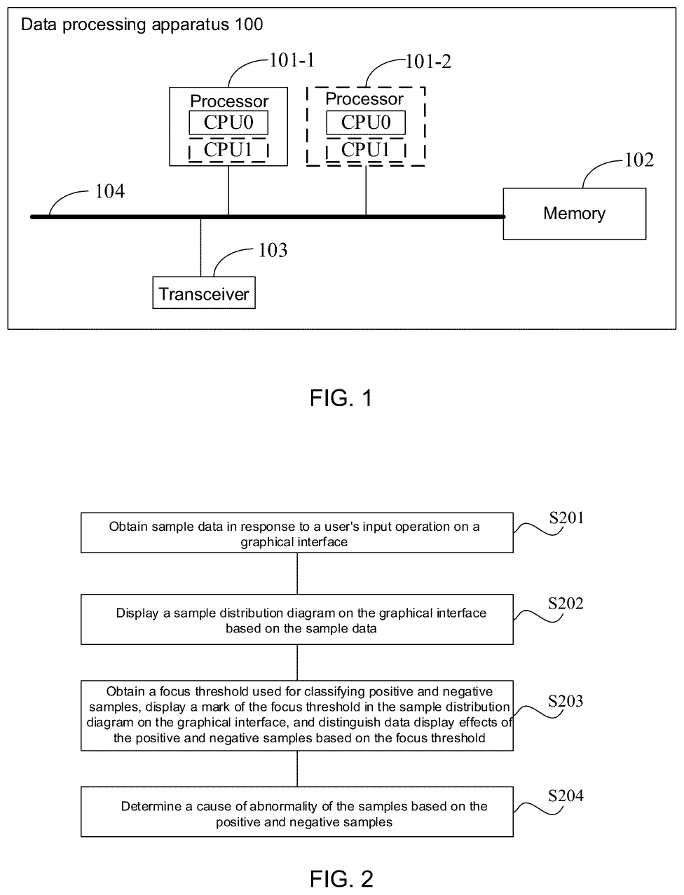

Referring to FIG. 1, the data processing apparatus 100 includes at least one processor 101, a memory 102, a transceiver 103 and a communication bus 104.

Components of the data processing apparatus 100 are described in detail below with reference to FIG. 1.

The processor 101 is a control center of the data processing apparatus 100, and the processor may be a single processor or a generic term for a plurality of processing elements. For example, the processor 101 may be a central processing unit (CPU), an application specific integrated circuit (ASIC), or one or more integrated circuits configured to implement the embodiments of the present disclosure.

The processor 101 may execute various functions of the data processing apparatus 100 by running or executing software programs stored in the memory 102 and calling data stored in the memory 102.

In a specific implementation, as an embodiment, the processor 101 may include one or more CPUs, such as a CPU0 and a CPU1 shown in FIG. 1.

In a specific implementation, as an embodiment, the data processing apparatus may include a plurality of processors 101, such as a processor 101-1 and another processor 101-2 shown in FIG. 1. Each of the plurality of processors may be a single-core processor or a multi-core processor. The processor(s) may be referred to as one or more detection devices, circuit(s), and/or processing core(s) used for processing data (e.g., computer program instructions).

The memory 102 may be a read-only memory (ROM) or any other type of static storage device capable of storing static information and instructions, a random access memory (RAM) or any other type of dynamic storage device capable of storing information and instructions. The memory 102 may also be an electrically erasable programmable read-only memory (EEPROM), a compact disc read-only memory (CD-ROM) or any other compact disc storage, an optical disc storage (e.g., a compressed disc, a laser disc, an optical disc, a digital versatile disc, a Blu-ray disc, etc.), a magnetic disc storage medium or any other magnetic storage device, or any other medium capable of carrying or storing a desired program code in a form of instructions or data structures and being accessed by a computer, but it is not limited thereto. The memory 102 may be provided independently and connected to the processor 101 through the communication bus 104. Alternatively, the memory 102 may be integrated with the processor 101.

The memory 102 is used to store the software programs for executing the solutions of the present disclosure, and the execution is controlled by the processor 101.

The transceiver 103 is used to communicate with other communication devices. Of course, the transceiver may be further used to communicate with communication networks, such as Ethernet, radio access network (RAN), wireless local area networks (WLAN), etc. The transceiver 103 may include a receiving unit having a receiving function, and a transmitting unit having a transmitting function.

The communication bus 104 may be an industry standard architecture (ISA) bus, a peripheral component interconnect (PCI) bus or an extended industry standard architecture (EISA) bus, etc. The bus may be an address bus, a data bus and a control bus. For ease of representation, in FIG. 1, the communication bus 104 is represented by only one thick line, but it does not indicate that there is only one bus or one type of buses.

The data processing apparatus is not limited to a structure of the data processing apparatus shown in FIG. 1. Based on the structure shown in FIG. 1, the data processing apparatus may include more or less components, or combine with some components, or include different components.

As shown in FIG. 2, the data processing method provided in the embodiments of the present disclosure includes the following steps (i.e., S201 to S204).

In S201, sample data is obtained in response to a user's input operation on a graphical interface.

The sample data includes characteristic data and detection data of samples.

Optionally, the detection data of each sample may be an abnormal degree of a certain event. In a production process, the detection data of each sample may be an abnormal ratio of products. The abnormal ratio is used to indicate a proportion of the number of abnormal sub-samples in each sample to the total number of sub-samples included in the sample. The detection data of each sample may also be a measurement parameter of the sample (e.g., a voltage, a current or a power of the sample).

In an example where the samples are glass substrates, each glass substrate may be cut into a plurality of panels after the glass substrate is performed various processes, and then each panel is transmitted into a detection site to perform a defect detection. The detection data of the sample may be an abnormal ratio of the sample, and the abnormal ratio of the sample refers to a proportion of the number of defective panels in the plurality of panels to the total number of the plurality of panels.

Optionally, the characteristic data of the sample may include, but are not limited to, at least one of product model, detection site, abnormal type, generation time, production equipment, environmental parameter, detection time and arrival ratio.

For example, each sample may include a plurality of sub-samples. The arrival ratio of the sample is used to indicate a proportion of the number of sub-samples actually detected in the sample to the total number of sub-samples included in the sample.

In an example where the samples are the glass substrates and sub-samples are panels, each glass substrate may be cut into a plurality of panels after the glass substrate is performed various processes, and then each panel is transmitted into the detection site to perform the defect detection. The arrival ratio of each sample refers to a proportion of the number of panels arriving at the detection site in the plurality of panels to the total number of the plurality of panels.

Optionally, the abnormal type of the sample includes, but are not limited to, oil stain, corrosion or bubble. In the embodiments of the present disclosure, when the cause of abnormality of the samples are analyzed, it is possible to analyze samples of the same abnormal type.

Optionally, the generation time of the sample may be production time or delivery time of the sample.

Optionally, the environmental parameter of the sample includes process parameters of sample processing, and a temperature and a pressure of an environment where the sample is processed.

For example, the description that the sample data is obtained by the data processing apparatus in response to the user's input operation on the graphical interface may include: receiving, by the data processing apparatus, a setting operation of characteristic data (such as the product model, the detection site, the generation time, the production equipment and the environmental parameter) input by the user on the graphical interface; and obtaining, by the data processing apparatus, the sample data in response to the setting operation input by the user.

For example, the description that the sample data is obtained by the data processing apparatus in response to the user's input operation on the graphical interface may include: receiving, by the data processing apparatus, an operation of uploading a file (e.g., csv file) by the user; and obtaining, by the data processing apparatus, the sample data in response to the operation of uploading the file.

Optionally, a method of obtaining the sample data includes manual import, batch import or real-time data import by the user. The manual import includes: receiving, by the data processing apparatus, the operation of uploading the file (e.g., the csv file) by the user; and obtaining, by the data processing apparatus, the sample data in response to the operation. That is, the user may use the sample data collected by the user as a sample set for abnormal diagnosis and analysis. The batch import may perform a one-time or periodic batch import of data by calling the application programming interface (API) or the address of the hadoop distributed file system (HDFS). The real-time data import may import data of a data source into the data processing apparatus in real time by tools of kafka and extract-transform-load (ETL). Specific methods of obtaining the sample data by the data processing apparatus are not limited in the embodiments of the present disclosure, and the above are only exemplary descriptions.

Optionally, in the embodiments of the present disclosure, the abnormal ratio and the measurement parameter may be used as evaluation indicators for measuring the abnormality of the sample, and the production equipment and the environmental parameter of the sample may be used as causes resulting in the abnormality of the sample.

In an example where the characteristic data of the sample includes the detection site Check Step, a defect type Defect_Name, the arrival ratio Input_Ratio and the generation time END_TIME, and the detection data of the sample includes the abnormal ratio Ratio, a sample set of which the defect type is Defect_code1 is as shown in Table 1.

TABLE 1

| | Check | | | | |
|---|---|---|---|---|---|
| GlassID | Step | Defect_Name | Ratio | Input_Ratio | END_TIME |
| GlassID | Check | Defect_code1 | 0.088 | 0.953 | Jan. 24, 2021 |
| 1 | Step1 | | | | 8:25:03 AM |
| GlassID | Check | Defect_code1 | 0.264 | 0.924 | Jan. 28, 2021 |
| 2 | Step1 | | | | 7:43:11 AM |
| . . . | . . . | . . . | . . . | . . . | . . . |
| GlassID | Check | Defect_code1 | 0.011 | 0.837 | Feb. 11, 2021 |
| n | Step1 | | | | 8:37:45 PM |

In S202, a sample distribution diagram is displayed on the graphical interface based on the sample data.

The sample data shown in Table 1 is taken as an example, a distribution diagram of the samples shown in Table 1 may be displayed on the graphical interface, a horizontal axis of the sample distribution diagram may be the generation time, and a vertical axis thereof may be the abnormal ratio.

In S203, a focus threshold used for classifying positive and negative samples is obtained, a mark of the focus threshold is displayed in the sample distribution diagram on the graphical interface, and data display effects of the positive and negative samples are distinguished based on the focus threshold.

The focus threshold is determined based on the detection data of the samples. The focus threshold may classify the samples into the positive and negative samples. Optionally, the positive samples may be referred to as normal samples or non-abnormal samples, and the negative samples may be referred to as defective samples or abnormal samples.

Optionally, the focus threshold may be determined by the data processing apparatus based on the detection data of the samples, or may be determined by the user according to the detection data of the samples. In a case where the focus threshold is determined by the user according to the detection data of the samples, the user may input the focus threshold determined thereby in the data processing apparatus. The data processing apparatus receives a user's setting operation of the focus threshold, displays the mark of the focus threshold in the sample distribution diagram on the graphical interface, and distinguishes the data display effects of the positive and negative samples based on the focus threshold.

Optionally, the data processing apparatus or the user may determine the focus threshold based on a distribution of the detection data of the samples.

Optionally, the focus threshold may include first focus threshold(s) or a second focus threshold.

For example, a description that the focus threshold is obtained by the data processing apparatus may include: receiving, by the data processing apparatus, a user's setting operation of the first focus threshold(s); or determining, by the data processing apparatus, the second focus threshold according to the detection data of the samples. Two implementations of which the data processing apparatus obtains the focus threshold will be specifically described below.

In a first implementation, the step S203 includes: receiving the user's setting operation of the first focus threshold(s); displaying mark(s) of the first focus threshold(s) in the sample distribution diagram on the graphical interface; and distinguishing the data display effects of the positive and negative samples based on the first focus threshold(s).

In the first implementation, the detection data of the samples may be the measurement parameters. According to different measurement parameters, it is possible that the measurement parameter is normal in a case where it is greater than the threshold and is abnormal in a case where it is less than the threshold; alternatively, it is possible that the measurement parameter is normal in a case where it is less than the threshold and is abnormal in a case where it is greater than the threshold; alternatively, it is possible that the measurement parameter is normal in a case where it is within a range and is abnormal in a case where it is outside the range; alternatively, it is possible that the measurement parameter is abnormal in a case where it is within the range and is normal in a case where it is outside the range. The user may set the threshold according to the different specific parameters.

Optionally, the first focus threshold(s) may include a value set by the user, or may constitute a range set by the user.

Optionally, in an example where the first focus threshold(s) set by the user include the value, the first focus threshold(s) includes a first value. Distinguishing the data display effects of the positive and negative samples based on the first focus threshold(s), includes: distinguishing the data display effects of the positive and negative samples based on a relationship between magnitudes of the detection data of the samples and a magnitude of the first value.

For example, based on the relationship between the magnitudes of the detection data of the samples and the magnitude of the first value, the data processing apparatus may classify samples whose detection data is greater than the first value as the negative samples, and classify samples whose detection data is less than the first value as the positive samples.

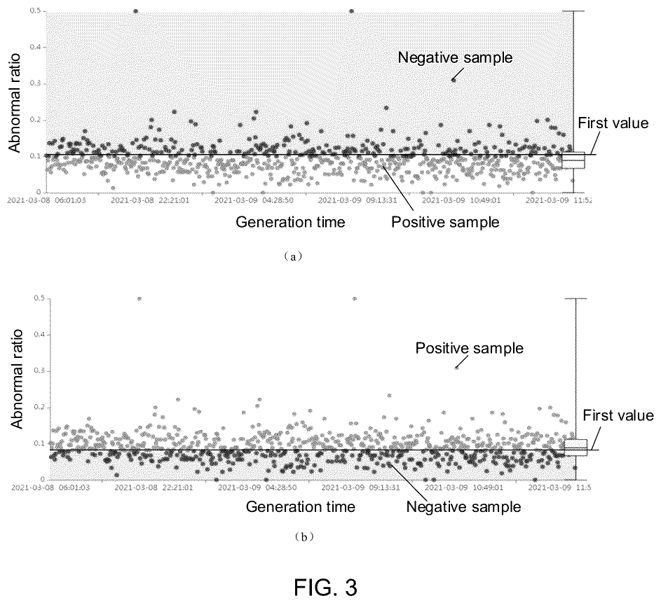

For example, as shown in (a) of FIG. 3, samples whose abnormal ratio is greater than the first value may be classified as the negative samples, and are represented by black dots; samples whose abnormal ratio is less than the first value may be classified as the positive samples, and are represented by gray dots.

For example, based on the relationship between the magnitudes of the detection data of the samples and the magnitude of the first value, the data processing apparatus may classify the samples whose the detection data is greater than the first value as the positive samples, and classify the samples whose the detection data is less than the first value as the negative samples.

For example, as shown in (b) of FIG. 3, the samples whose abnormal ratio is greater than the first value may be classified as the positive samples and are represented by the gray dots; the samples whose abnormal ratio is less than the first value may be classified as the negative samples and are represented by the black dots.

It will be noted that, the embodiments of the present disclosure do not limit whether the data processing apparatus classifies the samples whose detection data is greater than the first value as the positive samples or the negative samples. In practical applications, whether the samples whose detection data is greater than the first value are classified as the positive samples or the negative samples may be determined according to a type of the specific parameter of the detection data.

Optionally, in an example where the first focus threshold(s) set by the user includes two values, the first focus threshold(s) may include a second value and a third value, and the second value is less than the third value. Distinguishing the data display effects of the positive and negative samples based on the first focus threshold(s), includes: distinguishing the data display effects of the positive and negative samples based on whether the detection data of the sample is greater than the second value and less than the third value.

For example, the second value and the third value may constitute a range. Based on a relationship between the magnitudes of the detection data of the samples and a magnitude of the range, the data processing apparatus may classify samples whose detection data is greater than the second value and less than the third value as the positive samples, and classify samples whose detection data is less than the second value or greater than the third value as the negative samples.

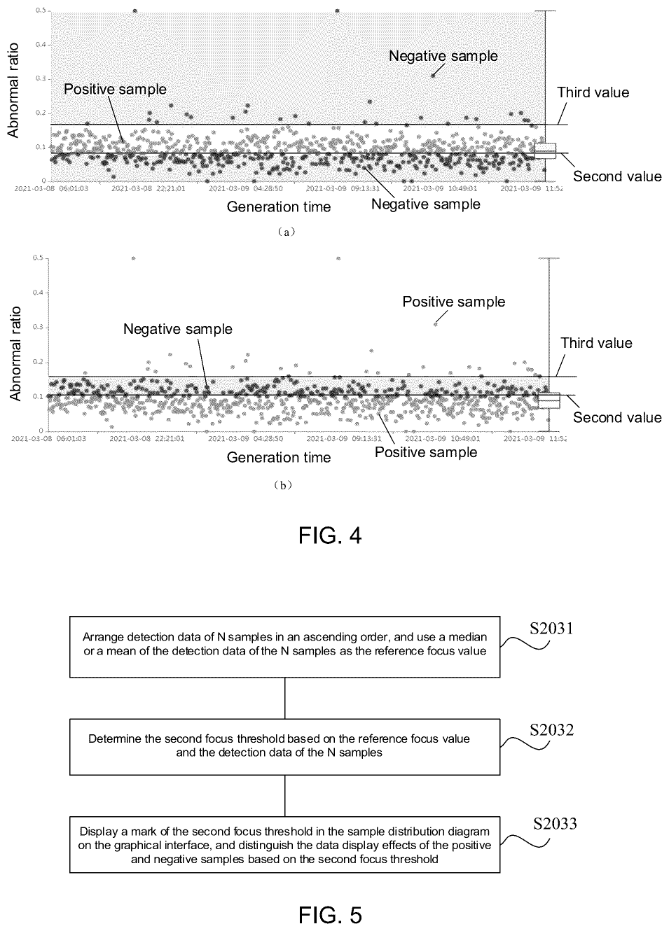

For example, as shown in (a) of FIG. 4, samples whose abnormal ratio is greater than the second value and less than the third value may be classified as the positive samples (that is, the samples whose abnormal ratio is above the second value and below the third value shown in (a) of FIG. 4 are the positive samples), and are represented by gray dots; samples whose abnormal ratio is less than the second value or greater than the third value may be classified as the negative samples (that is, the samples whose abnormal ratio is below the second value or above the third value shown in (a) of FIG. 4 are the negative samples), and are represented by black dots.

For example, the second value and the third value may constitute the range. Based on the relationship between the magnitudes of the detection data of the samples and the range, the data processing apparatus may classify the samples whose detection data is less than the second value or greater than the third value as the positive samples, and classify the samples whose detection data is greater than the second value and less than the third value as the negative samples.

For example, as shown in (b) of FIG. 4, the samples whose abnormal ratio is greater than the second value and less than the third value may be classified as the negative samples (that is, the samples whose abnormal ratio is above the second value and below the third value shown in (b) of FIG. 4 are the negative samples), and are represented by the black dots; the samples whose abnormal ratio is less than the second value or greater than the third value may be classified as the positive samples (that is, the samples whose abnormal ratio is below the second value or above the third value shown in (b) of FIG. 4 are the positive samples), and are represented by the gray dots.

In a second implementation, in the step S203, the description that the focus threshold used for classifying the positive and negative samples is obtained may include: obtaining, by the data processing apparatus, the focus threshold based on the distribution of the detection data of the samples. For example, the data processing apparatus may use a concentration trend characteristic (e.g., a median, a mean, etc.) of the detection data of the samples as a reference focus value, and use the reference focus value as the second focus threshold. For another example, the data processing apparatus may use the concentration trend characteristic (e.g., the median, the mean, etc.) of the detection data of the samples as the reference focus value, and further determine the second focus threshold based on a distribution of detection samples classified by the reference focus value.

In an example where the number of samples is N, as shown in FIG. 5, the step S203 may include steps S2031 to S2033.

In S2031, detection data of N samples are arranged in an ascending order, and a median or a mean of the detection data of the N samples is used as the reference focus value.

Optionally, the N samples may be samples that have been screened in the following step S205, or may be samples that have not been screened in the step S205, which are not limited in the embodiments of the present disclosure.

Optionally, in a case where the data processing apparatus uses the median or the mean of the detection data of the N samples as the reference focus value, a reference focus index may be a value corresponding to the reference focus value.

For example, in a case where the data processing apparatus uses the median of the detection data of the N samples as the reference focus value, the reference focus index may be ┌N/2┐, where ┌N/2┐ means that N/2 is rounded off to an integer. For example, N is 401, the reference focus value is a median of 401 detection data, and the reference focus index is 201.

For another example, in a case where the data processing apparatus uses the mean of the detection data of the N samples as the reference focus value, the reference focus index may be an index of the detection data that is the closest to the mean. For example, in the detection data of the N samples arranged in sequence, detection data of a 600-th sample is the closest to the mean, and thus the reference focus index may be determined to be 600.

The embodiments of the present disclosure do not limit a specific method of determining the reference focus value, and the following embodiments are described by taking an example where the reference focus index is the ┌N/2┐ and the reference focus value is ┌N/2┐-th detection data.

In an example where the detection data of the samples is the abnormal ratios of the samples, the data processing apparatus may arrange abnormal ratios of the N samples in the ascending order to obtain an array SortedData SortedData=[x₁,x₂,x₃, . . . ,xᵢ, . . . ,x_{N}], where xᵢ is represented as an i-th abnormal ratio.

In an example where the reference focus value is the median, the data processing apparatus may take a median value of the total number of the samples as the reference focus index. For example, if the total number of the samples is even, N/2 is taken as the reference focus index; if the total number of the samples is odd, the median value ┌N/2┐ is taken as the reference focus index.

For example, the number of N samples is 1000 and the detection data of the samples is the abnormal ratios of the samples, the abnormal ratios of the 1000 samples are arranged in the ascending order to obtain the array SortedData SortedData=[x₁,x₂,x₃, . . . ,x₁₀₀₀]. The reference focus index is determined as 500, and a 500-th abnormal ratio x₅₀₀ in the array SortedData is used as the reference focus value, which may classify the SortedData into LowerGroup and UpperGroup.

$$SortedData = \{ \begin{matrix}LowerGroup , & {x}_{i} \leq {x}_{500} \\ UpperGroup , & {x}_{i} > {x}_{500}\end{matrix} , i = 1 , 2 , 3 , … 1000.$$

In S2032, the second focus threshold is determined based on the reference focus value and the detection data of the N samples.

Optionally, based on the reference focus value and the detection data of the N samples, the second focus threshold may be determined by using the AutoFocus algorithm.

For example, determining the second focus threshold based on the reference focus value and the detection data of the N samples in S2032 may include the following steps (i.e., steps a to c).

In step a, detection data, less than or equal to the reference focus value, of the detection data of the N samples is averaged to obtain a first mean Meanₗ; and detection data, greater than the reference focus value, of the detection data of the N samples is averaged to obtain a second mean Meanᵤ.

For example, according to the reference focus value, the data processing apparatus may classify the detection data, less than or equal to the reference focus value, of the detection data of the N samples as the LowerGroup, and may classify the detection data, greater than the reference focus value, of the detection data of the N samples as the UpperGroup. Moreover, the detection data in the LowerGroup is averaged to obtain the first mean Meanₗ, and the detection data in the UpperGroup is averaged to obtain the second mean Meanᵤ.

For example, the number of the samples is 1000 and the detection data of the samples is the abnormal ratios of the samples, according to the reference focus value x₅₀₀), the data processing apparatus averages x₁ to x₅₀₀ in the SortedData to obtain the Meanₗ, and averages x₅₀₁ to x₁₀₀₀ in the SortedData to obtain the Meanᵤ.

In step b, a difference between each of the detection data of the N samples that are arranged in sequence and the first mean Meanₗ are made one by one, and an absolute value of each difference is taken to obtain a first mean difference DiffLowerMean, DiffLowerMean=[l₁,l₂,l₃ . . . ,lᵢ . . . ,l_{N}]. A difference between each of the detection data of the N samples that are arranged in sequence and the second mean Meanᵤ are made one by one, and an absolute value of each difference is taken to obtain a second mean difference DiffUpperMean, DiffUpperMean=[u₁,u₂,u₃ . . . ,uᵢ . . . ,u_{N}]. Each element in the first mean difference and a respective element in the second mean difference are compared one by one, and the number k of which lᵢ is less than uᵢ(lᵢ<uᵢ) is determined, where i=1,2,3, . . . , N. The reference focus index is updated to k, and in the detection data of the N samples arranged in sequence, the reference focus value is updated to a value of k-th detection data.

For example, the number of the samples is 1000 and the detection data of the samples is the abnormal ratios of the samples, the data processing apparatus makes a difference between each of 1000 data in the SortedData and Meanₗ; and an absolute value of each difference is taken to obtain the first mean difference DiffLowerMean, DiffLowerMean=[l₁,l₂,l₃ . . . ,l₁₀₀₀]. Moreover, the data processing apparatus makes a difference between each of the 1000 data in the SortedData and Meanᵤ; and an absolute value of each difference is taken to obtain the second mean difference DiffUpperMean, DiffUpperMean=[u₁,u₂,u₃ . . . ,u₁₀₀₀]. A magnitude of an i-th value lᵢ in the DiffLowerMean is compared with a magnitude of an i-th value uᵢ in the DiffUpperMean. For example, in sequence, a magnitude of a first value l₁ in the DiffLowerMean is compared with a magnitude of a first value u₁ in the DiffUpperMean, a magnitude of a second value l₂ in the DiffLowerMean is compared with a magnitude of a second value u₂ in the DiffUpperMean, a magnitude of a third value l₃ in the DiffLowerMean is compared with a magnitude of a third value u₁ in the DiffUpperMean, and so on. Thus, the number k of which l₂ is less than uᵢ(lᵢ<uᵢ) is determined. For example, k is 700, the reference focus index is determined as 700, and the reference focus value is updated to a 700-th abnormal ratio x₇₀₀ in the array SortedData.

In step c, the step a and the step b are repeated until a value of the reference focus index does not change before and after an update, and in the detection data of the N samples arranged in sequence, the second focus threshold is determined based on detection data corresponding to the reference focus index.

For example, the step a is continued to be performed, according to the reference focus value x₇₀₀), the data processing apparatus averages x₁ to x₇₀₀ in the SortedData to obtain Meanₗ, and averages x₇₀₁ to x₁₀₀₀ in the SortedData to obtain Meanᵤ. In the step b, the data processing apparatus makes a difference between each of the 1000 data in the SortedData and Meanₗ; and an absolute value of each difference is taken to obtain the first mean difference DiffLowerMean, DiffLowerMean=[l₁,l₂,l₃ . . . ,l₁₀₀₀]. And the data processing apparatus makes a difference between each of the 1000 data in the SortedData and Meanᵤ; and an absolute value of each difference is taken to obtain the second mean difference DiffUpperMean, DiffUpperMean=[u₁,u₂,u₃ . . . ,u₁₀₀₀]. The magnitude of the i-th value lᵢ in the DiffLowerMean is compared with the magnitude of the i-th value uᵢ in the DiffUpperMean one by one. Thus, the number k of which lᵢ is less than uᵢ(lᵢ<uᵢ) is determined. For example, k is 750, the reference focus index is determined as 750, and the reference focus value is updated to a 750-th abnormal ratio x₇₅₀) in the array SortedData. And then, according to the reference focus value x₇₅₀, the steps a and b are continued to be performed. If the number k of which lᵢ is less than uᵢ (lᵢ<uᵢ) is still determined as 750, the reference focus index is determined to be 750, and the second focus threshold is determined based on the 750-th abnormal ratio x₇₅₀ in the array SortedData.

Optionally, in a case where the data processing apparatus determines the second focus threshold based on detection data corresponding to a constant reference focus index, the detection data corresponding to the reference focus index may be determined as the second focus threshold, or the second focus threshold may be obtained by averaging the detection data corresponding to the reference focus index and previous detection data thereof. The embodiments of the present disclosure do not limit a specific method of determining the second focus threshold based on the detection data corresponding to the reference focus index.

In an example where the value of the reference focus index is 750 before the update and the value of the reference focus index is 750 after the update, the data processing apparatus may determine the 750-th abnormal ratio x₁₅₀ in the array SortedData as the second focus threshold, or may determine the second focus threshold by averaging a 749-th abnormal ratio x₇₄₉ and the 750-th abnormal ratio x₇₅₀ in the array SortedData.

In S2033, a mark of the second focus threshold is displayed in the sample distribution diagram on the graphical interface, and the data display effects of the positive and negative samples are distinguished based on the second focus threshold.

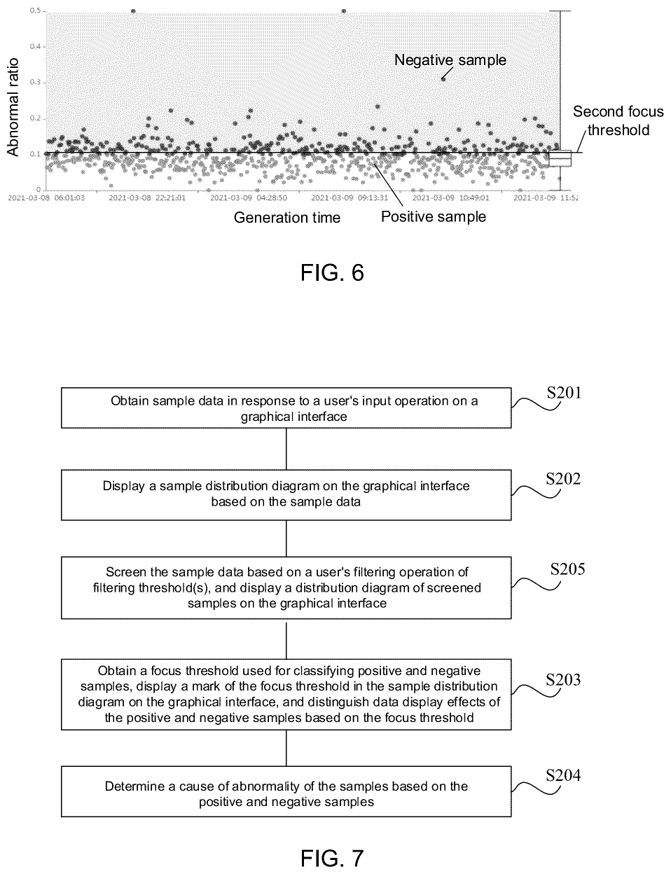

In an example where the detection data of the samples is the abnormal ratios of the samples, as shown in FIG. 6, the mark of the second focus threshold is displayed on the graphic interface, and the second focus threshold may distinguish the positive and negative samples. Black dots above the second focus threshold represent the negative samples, and gray dots below the second focus threshold represent the positive samples.

It may be understood that, in the second implementation, the data processing apparatus determines the second focus threshold according to the detection data of the samples, and classifies the positive and negative samples based on the second focus threshold, so that the data analysis based on the positive and negative samples is more accurate.

It may be understood that, in the embodiments of the present disclosure, the data processing apparatus determines the focus threshold based on the detection data of the samples, or the data processing apparatus obtains the focus threshold by receiving the user's setting operation of the first focus threshold(s), so that the positive and negative samples can be classified reasonably based on the focus threshold, and the data analysis is more accurate.

In S204, the cause of abnormality of the samples is determined based on the positive and negative samples.

For example, after the data processing apparatus classifies the positive and negative samples based on the focus threshold, the sample feature analysis or the training of the machine learning model is performed based on the abnormal samples in the positive and negative samples, which may analyze the sample data or train the model more accurately.

In the embodiments of the present disclosure, determining the cause of abnormality of the samples based on the positive and negative samples, includes: performing the sample feature analysis based on the positive and negative samples; and using a statistical analysis method such as the weight of evidence (WOE), the Pearson correlation analysis or the decision tree algorithm to analyze the characteristic data causing abnormal detection results of the samples, so as to obtain a degree of an influence of the characteristic data on the detection results. In another embodiment of the present disclosure, determining the cause of abnormality of the samples based on the positive and negative samples, further includes: based on the classification of the positive and negative samples as input data, using the machine learning model such as the logistic regression, the random forest, the light gradient boosting machine (LGBM), the extreme gradient boosting (Xgboost) or the categorical boosting (CatBoost) to perform the training, so as to obtain a sample abnormality prediction model and an importance ranking of the characteristic data of the samples. The embodiments of the present disclosure do not limit a specific method of determining the cause of abnormality of the samples based on the positive and negative samples, and the above are only exemplary descriptions.

In the data processing method provided in the embodiments of the present disclosure, the data processing apparatus determines the focus threshold based on the detection data of the samples, and displays the data display effects of the positive and negative samples distinguished based on the focus threshold in the sample distribution diagram on the graphical interface. The embodiments of the present disclosure may classify the positive and negative samples reasonably, so that the sample data may be analyzed more accurately according to the classified positive and negative samples or the model may be trained more accurately according to the classified positive and negative samples. Thus, accuracies of the determined cause of abnormality of the samples or accuracy of the model may be relatively high.

FIG. 7 is another data processing method provided in the embodiments of the present disclosure. In addition to the above steps S201 to S204, the data processing method may further include step S205.

In S205, the sample data is screened based on a user's filtering operation of filtering threshold(s), and a distribution diagram of screened samples is displayed on the graphical interface.

The filtering threshold(s) includes at least one of an abnormal ratio threshold, an arrival ratio threshold, a production equipment threshold, an environmental parameter threshold, a detection time threshold or a generation time threshold.

Optionally, the step S205 may be performed before the step S203 or after the step S203, which is not limited in the embodiments of the present disclosure. FIG. 7 illustrates an example where the step S205 is performed before the step S203. It may be understood that, in a case where the step S205 is performed before the step S203, the data processing apparatus may screen the sample data based on the filtering threshold, determine the focus threshold based on detection data of the screened samples, classify the positive and negative samples based on the focus threshold, and determine the cause of abnormality of the samples based on the positive and negative samples. In a case where the step S205 is performed after the step S203, the data processing apparatus may screen the sample data based on the filtering threshold, re-determine the focus threshold based on the detection data of the screened samples, classify the positive and negative samples based on the re-determined focus threshold, and determine the cause of abnormality of the samples based on the positive and negative samples.

Optionally, the filtering operation may include a setting operation or a selecting operation. The selecting operation may include an option box operation.

Optionally, each filtering threshold may include a value or a plurality of values, which is not limited in the embodiments of the present disclosure.

In an example where the filtering threshold includes the abnormal ratio threshold, the abnormal ratio is used to indicate the proportion of the number of abnormal sub-samples in each sample to the total number of sub-samples included in the sample. Since an amount of the sample data obtained by the data processing apparatus is relatively large, the user may set the abnormal ratio threshold. Based on the abnormal ratio threshold set by the user, the data processing apparatus may screen the sample data, and filter out samples whose abnormal ratio is less than the abnormal ratio threshold. It may be understood that, reliability of the sample analysis may be improved by deleting samples with a low abnormal ratio and no reference value.

In an example where the filtering threshold includes the arrival ratio threshold, the arrival ratio is used to indicate the proportion of the number of sub-samples actually detected in each sample to the total number of sub-samples included in the sample. Since there may be some sub-samples in each sample not arriving at the detection site to perform the detection, the number of sub-samples actually detected may be less than the total number of sub-samples in the sample. Therefore, as for the sample with the low abnormal ratio, it is possible that some sub-samples are not detected, resulting in the low abnormal ratio of the sample. That is, in a case where the arrival ratio of the sample is relatively low, since most of the sub-samples included in the sample do not arrive at the detection site to perform the detection, an accuracy of the abnormal ratio of the sample is relatively low. In order to improve the accuracies of the abnormal ratios of the samples, samples with the low arrival ratio may be filtered out, and samples with a high arrival ratio may be retained, so as to ensure a high reliability of the sample analysis.

In the example where the samples are glass substrate, each glass substrate may be cut into the plurality of panels after the glass substrate is performed various processes, and then each panel is transmitted into the detection site to perform the defect detection. An arrival ratio of each glass substrate is a proportion of the number of panels arriving at the detection site in the plurality of panels to the total number of the plurality of panels, and an abnormal ratio of each glass substrate is a proportion of the number of abnormal panels in the plurality of panels to the total number of in the plurality of panels. In order to improve the accuracy of the abnormal ratio and avoid a situation where the abnormal ratio of glass substrate is low due to some panels not arriving at the detection site to perform the detection, the user may set the arrival ratio threshold (e.g., the arrival ratio threshold is 0.9) according to experience, and the data processing apparatus screens the sample data based on the arrival ratio threshold set by the user and filters out samples whose arrival ratio less than the arrival ratio threshold of 0.9.

In an example where the filtering thresholds includes the production equipment threshold and the environmental parameter threshold, in order to facilitate the user to narrow an analysis scope of the samples, the user may set the production equipment threshold and the environmental parameter threshold. Based on the production equipment threshold and the environmental parameter threshold set by the user, the data processing apparatus may screen the sample data, filter out samples not meeting the production equipment threshold and the environmental parameter threshold and retain samples meeting the production equipment threshold and the environmental parameter threshold. It may be understood that, by deleting samples that are useless for the analysis, the data processing apparatus may improve purity of diagnosing and analyzing of data, and improve the accuracy of the data analysis.

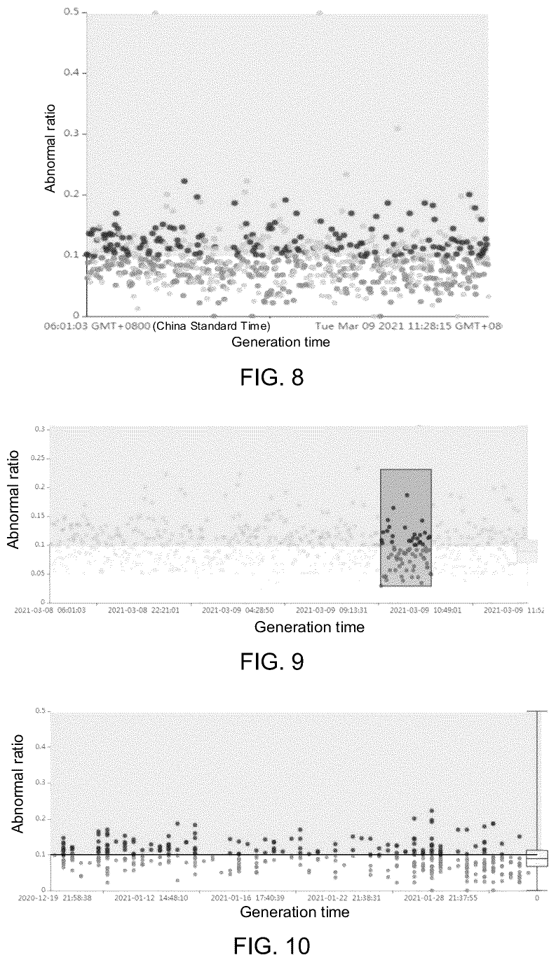

For example, as shown in FIG. 8, in order to narrow the analysis scope of the samples and improve the reliability of the data analysis, after the user inputs the setting operation of the production equipment threshold and the environmental parameter threshold, in response to the user's setting operation, the data processing apparatus displays samples to be filtered out (gray dots with the lightest color shown in FIG. 8) on a display interface thereof, and then filters out the samples. After filtering, the number and distribution of samples will change, and the focus threshold may be re-obtained in combination with the step S203.

In an example where the filtering threshold includes the detection time threshold, the user may select the detection time threshold. Based on the detection time threshold selected by the user, the data processing apparatus deletes samples whose detection time meets the detection time threshold selected by the user, or the data processing apparatus deletes samples whose detection time does not meet the detection time threshold selected by the user.

For example, as shown in FIG. 9, after the user inputs the option box operation of the detection time threshold, in response to the user's option box operation, the data processing apparatus displays the detection time threshold selected by the use on the display interface thereof, deletes samples whose detection time meets the detection time threshold selected by the user, and classifies the screened samples into the positive and negative samples based on the focus threshold.

In an example where the filtering threshold includes the generation time threshold, the user may select the generation time threshold. Based on the generation time threshold selected by the user, the data processing apparatus deletes samples whose generation time meets the generation time threshold selected by the user, or the data processing apparatus deletes samples whose generation time does not meet the generation time threshold selected by the user.

For example, as shown in FIG. 10, after the user inputs the setting operation of the generation time threshold, in response to the user's setting operation, the data processing apparatus filters out samples whose generation time does not meet the generation time threshold set by the user, displays samples whose generation time meets the generation time threshold set by the user on the display interface, and classifies the screened samples into the positive and negative samples based on the focus threshold.

It may be understood that, in a case where the filtering thresholds include a plurality of thresholds in the abnormal ratio threshold, the arrival ratio threshold, the production equipment threshold, the environmental parameter threshold, the detection time threshold or the generation time threshold, the data processing apparatus may sequentially filter the sample data based on the plurality of thresholds set by the user. The embodiments of the present disclosure do not limit a sequence in which the data processing apparatus screens the samples based on the plurality of filtering thresholds.

In the data processing method provided in the embodiments of the present disclosure, the data processing apparatus screens the sample data based on the filtering threshold(s), determines the focus threshold based on the detection data of the screened samples, and displays the data display effects of the positive and negative samples distinguished based on the focus threshold in the sample distribution diagram on the graphical interface. That is, in the embodiments of the present disclosure, by screening the sample data, some samples that have no reference value or affect the accuracy of the result of the sample analysis can be filtered out. Thus, the reliability of the sample data may be improved, and the result of the sample analysis is more reliable. Moreover, by classifying the positive and negative samples reasonably, the sample data may be analyzed more accurately according to the classified positive and negative samples or the model may be trained more accurately according to the classified positive and negative samples. Thus, the accuracies of the determined cause of abnormality of the samples or the accuracy of the model may be relatively high.

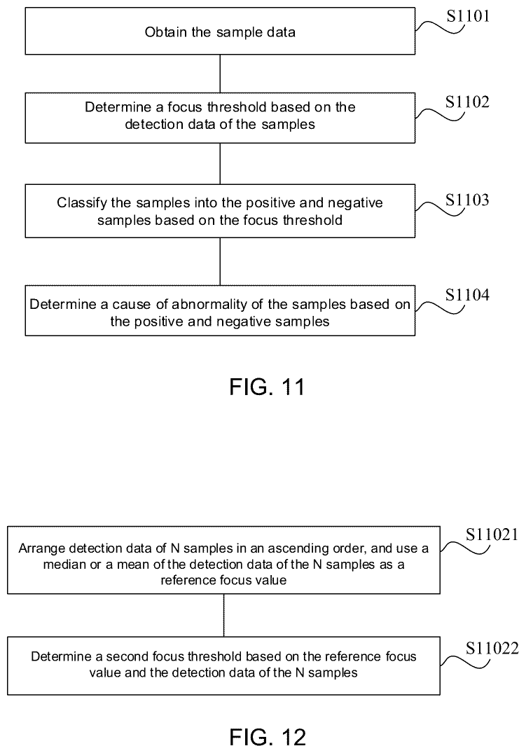

FIG. 11 is yet another data processing method provided in the embodiments of the present disclosure, as shown in FIG. 11, the method includes the following steps (i.e., S1101 to S1104).

In S1101, the sample data is obtained.

The sample data includes characteristic data and detection data of samples.

It may be understood that, a specific implementation of S1101 may refer to S201, which will not be described in detail here.

In S1102, a focus threshold is determined based on the detection data of the samples.

Optionally, as shown in FIG. 12, a description that the data processing apparatus determines the focus threshold based on the detection data of the samples, may include steps S11021 and S11022.

In S11021, detection data of N samples are arranged in an ascending order, and a median or a mean of the detection data of the N samples is used as a reference focus value.

Optionally, in a case where the data processing apparatus uses the median or the mean of the detection data of the N samples as the reference focus value, a reference focus index may be a value corresponding to the reference focus value.

For example, in a case where the data processing apparatus uses the median of the detection data of the N samples as the reference focus value, the reference focus index may be ┌N/2┐, ┌N/2┐ means that N/2 is rounded off to an integer.

For another example, in a case where the data processing apparatus uses the mean of the detection data of the N samples as the reference focus value, the reference focus index may be an index of the detection data that is the closest to the mean.

The embodiments of the present disclosure do not limit a specific method of determining the reference focus value, and the following embodiments are described by taking an example where the reference focus index is the ┌N/2┐ and the reference focus value as is ┌N/2┐-th detection data.

In an example where the detection data of the samples is the abnormal ratios of the samples, the data processing apparatus may arrange abnormal ratios of the N samples in the ascending order to obtain an array SortedData SortedData=[x₁,x₂,x₃, . . . ,xᵢ, . . . x_{N}], where xᵢ is represented as an i-th abnormal ratio.

For example, the data processing apparatus may take a median value of the total number of the samples as the reference focus index. For example, if the total number of the samples is even, the N/2 is taken as the reference focus index; if the total number of the samples is odd, the median value ┌N/2┐ is taken as the reference focus index.

In S11022, a second focus threshold is determined based on the reference focus value and the detection data of the N samples.

Optionally, based on the reference focus value and the detection data of the N samples, the second focus threshold Focus may be determined by using the AutoFocus algorithm.

For example, determining the second focus threshold based on the reference focus value and the detection data of the N samples in S11022 may include the following steps (i.e., steps a to c).

In step a, detection data, less than or equal to the reference focus value, of the detection data of the N samples is averaged to obtain a first mean Meanₗ; and detection data, greater than the reference focus value, of the detection data of the N samples is averaged to obtain a second mean Meanᵤ.

For example, according to the reference focus value, the data processing apparatus may classify the detection data, less than or equal to the reference focus value, of the detection data of the N samples as LowerGroup, and may classify the detection data, greater than the reference focus value, of the detection data of the N samples as UpperGroup. Moreover, the detection data in the LowerGroup is averaged to obtain the first mean Meanₗ, and the detection data in the UpperGroup is averaged to obtain the second mean Meanᵤ.

In step b, a difference between each of the detection data of the N samples that are arranged in sequence and the first mean Meanₗ are made one by one, and an absolute value of each difference is taken to obtain a first mean difference DiffLowerMean, DiffLowerMean=[l₁,l₂,l₃ . . . ,lᵢ . . . ,l_{N}]. A difference between each of the detection data of the N samples that are arranged in sequence and the second mean Meanᵤ are made one by one, and an absolute value of each difference is taken to obtain a second mean difference DiffUpperMean, DiffUpperMean=[u₁,u₂,u₃ . . . , uᵢ . . . ,u_{N}]. Each element in the first mean difference and a respective element in the second mean difference are compared one by one, and the number k of which lᵢ is less than uᵢ(lᵢ<uᵢ) is determined, where i=1,2,3, . . . , N. The reference focus index is updated to k, and in the detection data of the N samples arranged in sequence, the reference focus value is updated to a value of the k-th detection data.

In step c, the step a and the step b are repeated until a value of the reference focus index does not change before and after an update, and in the detection data of the N samples arranged in sequence, the second focus threshold is determined based on detection data corresponding to the reference focus index.

Optionally, in a case where the data processing apparatus determines the second focus threshold based on detection data corresponding to a constant reference focus index, the detection data corresponding to the reference focus index may be determined as the second focus threshold, or the second focus threshold may be obtained by averaging the detection data corresponding to the reference focus index and previous detection data thereof. The embodiments of the present disclosure do not limit a specific method of determining the second focus threshold based on the detection data corresponding to the reference focus index.

In S1103, the samples are classified into the positive and negative samples based on the focus threshold.

Optionally, the data processing apparatus may classify the samples into the positive and negative samples based on a relationship between magnitudes of the detection data of the samples and a magnitude of the focus threshold.

For example, in a case where the focus threshold may be a value, based on the relationship between the magnitudes of the detection data of the samples and the magnitude of the focus threshold, the data processing apparatus may classify samples whose detection data is greater than the focus threshold as the negative samples, and classify samples whose detection data is less than the focus threshold as the positive samples; alternatively, based on the relationship between the magnitudes of the detection data of the samples and the magnitude of the focus threshold, the data processing apparatus may classify samples whose detection data is greater than the focus threshold as the positive samples, and classify samples whose detection data is less than the focus threshold as the negative samples.

For example, in a case where the focus threshold may be a numerical range, based on whether each of the detection data of the samples is within the numerical range, the data processing apparatus may classify samples whose detection data is within the numerical range as the negative samples, and classify samples whose detection data is outside the numerical range as the positive samples; alternatively, based on whether each of the detection data of the samples is within the numerical range, the data processing apparatus may classify samples whose detection data is within the numerical range as the positive samples, and classify samples whose detection data is outside the numerical range as the negative samples.

In S1104, the cause of abnormality of the samples is determined based on the positive and negative samples.

For example, after the data processing apparatus classifies the positive and negative samples based on the focus threshold, the sample feature analysis or the training of the machine learning model is performed based on the abnormal samples in the positive and negative samples, which may analyze the sample data or train the model more accurately.

In the embodiments of the present disclosure, determining the cause of abnormality of the samples based on the positive and negative samples, includes: performing the sample feature analysis based on the positive and negative samples; and using a statistical analysis method such as the weight of evidence (WOE), the Pearson correlation analysis or the decision tree algorithm to analyze the characteristic data causing abnormal detection results of the samples, so as to obtain a degree of an influence of the characteristic data on the detection results. In another embodiment of the present disclosure, determining the cause of abnormality of the samples based on the positive and negative samples, further includes: based on the classification of the positive and negative samples as input data, using the machine learning model such as the logistic regression, the random forest, the light gradient boosting machine (LGBM), the extreme gradient boosting (Xgboost) or the categorical boosting (CatBoost) to perform the training, so as to obtain a sample abnormality prediction model and an importance ranking of the characteristic data of the samples.

In the data processing method provided in the embodiments of the present disclosure, the data processing apparatus determines the focus threshold based on the detection data of the samples, and based on the focus threshold, classifies the positive and negative samples reasonably, so that the sample data may be analyzed more accurately according to the classified positive and negative samples or the model may be trained more accurately according to the classified positive and negative samples. Thus, the accuracies of the determined cause of abnormality of the samples or the accuracy of the model may be relatively high.

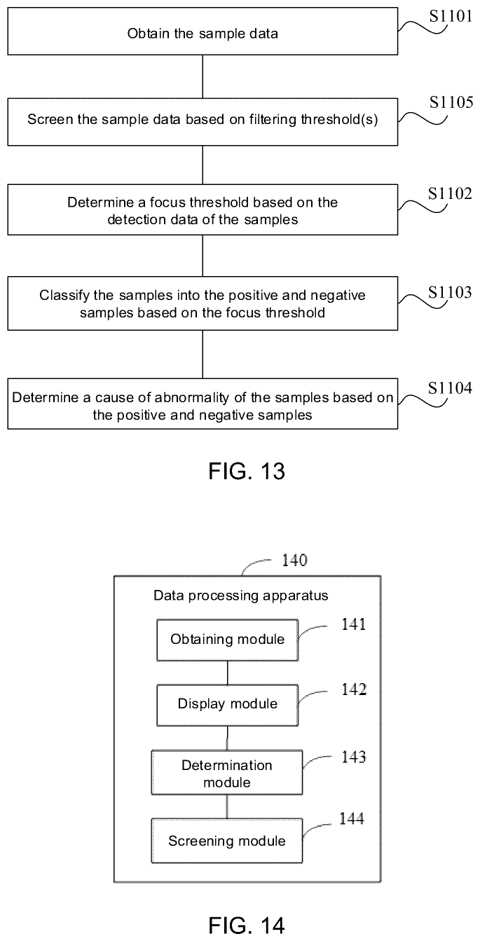

FIG. 13 shows yet another data processing method provided in the embodiments of the present disclosure. In addition to the above steps S1101 to S1104, the data processing method may further include step S1105.

In S1105, the sample data is screened based on filtering threshold(s).

The filtering threshold(s) includes at least one of an abnormal ratio threshold, an arrival ratio threshold, a production equipment threshold, an environmental parameter threshold, a detection time threshold or a generation time threshold.

Optionally, the step S1105 may be performed before the step S1102 or after the step S1102, which is not limited in the embodiments of the present disclosure. FIG. 13 illustrates an example where the step S1105 is performed before the step S1102. It may be understood that, in a case where the step S1105 is performed before the step S1102, the data processing apparatus may screen the sample data based on the filtering threshold, determine the focus threshold based on detection data of the screened samples, classify the positive and negative samples based on the focus threshold, and determine the cause of abnormality of the samples based on the positive and negative samples. In a case where the step S1105 is performed after the step S1102, the data processing apparatus may screen the sample data based on the filtering threshold, re-determine the focus threshold based on the detection data of the screened samples, classify the positive and negative samples based on the re-determined focus threshold, and determine the cause of abnormality of the samples based on the positive and negative samples.

It may be understood that, a specific implementation of the step S1105 may refer to the step S205, which will not be described in detail here.

It may be understood that, in a case where the filtering thresholds include a plurality of thresholds in the abnormal ratio threshold, the arrival ratio threshold, the production equipment threshold, the environmental parameter threshold, the detection time threshold or the generation time threshold, the data processing apparatus may sequentially filter the sample data based on the plurality of thresholds set by the user. The embodiments of the present disclosure do not limit a sequence in which the data processing apparatus screens the samples based on the plurality of filtering thresholds.

In the data processing method provided in the embodiments of the present disclosure, the data processing apparatus screens the sample data based on the filtering threshold(s), determines the focus threshold based on the detection data of the screened samples, and classifies the positive and negative samples based on the focus threshold. That is, in the embodiments of the present disclosure, by screening the sample data, some samples that have no reference value or affect the accuracy of the result of the sample analysis can be filtered out. Thus, the reliability of the sample data may be improved, and the result of the sample analysis is more reliable. Moreover, by classifying the positive and negative samples reasonably, the sample data may be analyzed more accurately according to the classified positive and negative samples or the model may be trained more accurately according to the classified positive and negative samples. Thus, the accuracies of the determined cause of abnormality of the samples or the accuracy of the model may be relatively high.

The foregoing descriptions mainly introduce the solutions provided in the embodiments of the present disclosure from a perspective of method. In order to realize the above functions, the foregoing descriptions may include corresponding hardware structures and/or software modules for performing respective functions. A person skilled in the art will be easy to realize that the embodiments of the present disclosure may be implemented through hardware or a combination of hardware and computer software by combining units and algorithm steps of the examples described in the embodiments disclosed herein. Whether a certain function is performed through hardware or computer software-driven hardware depends on a specific application and design constraints of technical solutions. A skilled person may use different methods for each specific application to implement the described functions, but the implementation should not be considered as beyond the scope of the present disclosure.

Embodiments of the present disclosure further provide a data processing apparatus. FIG. 14 is a structural diagram of the data processing apparatus 140 provided in the embodiments of the present disclosure. The data processing apparatus 140 is used to perform the data processing method as described in any of the above embodiments. The data processing apparatus 140 may include an obtaining module 141, a display module 142, a determination module 143 and a screening module 144.

The obtaining module 141 is used to obtain the sample data in response to the user's input operation on the graphical interface. The sample data includes the characteristic data and the detection data of the samples. The display module 142 is used to display the sample distribution diagram on the graphical interface based on the sample data. The obtaining module 141 is further used to obtain the focus threshold for classifying the positive and negative samples. The display module 142 is further used to, based on the focus threshold obtained by the obtaining module 141, display the mark of the focus threshold in the sample distribution diagram on the graphical interface, and distinguish the data display effects of the positive and negative samples based on the focus threshold.

The focus threshold is determined based on the detection data of the samples. The determination module 143 is used to determine the cause of abnormality of the samples based on the positive and negative samples.

Optionally, the characteristic data of the samples includes at least one of the product model, the detection site, the abnormal type, the arrival ratio, the production equipment, the environmental parameter, the detection time or the generation time.

Optionally, the detection data of the samples includes at least one of the abnormal ratio or the measurement parameter.

In some embodiments, the focus threshold includes the second focus threshold. In an example where the number of samples is N, the obtaining module 141 is used to: arrange the detection data of the N samples in the ascending order; use the median or the mean of the detection data of the N samples as the reference focus value; and determine the second focus threshold based on the reference focus value and the detection data of the N samples. The display module 142 is used to: display the mark of the second focus threshold in the sample distribution diagram on the graphical interface, and distinguish the data display effects of the positive and negative samples based on the second focus threshold.

In some other embodiments, the obtaining module 141 is further used to perform the following steps (i.e., the steps a to c). In the step a, detection data, less than or equal to the reference focus value, of the detection data of the N samples is averaged to obtain the first mean Meanₗ; and detection data, greater than the reference focus value, of the detection data of the N samples is averaged to obtain the second mean Meanᵤ. In the step b, the difference between each of the detection data of the N samples that are arranged in sequence and the first mean Meanₗ are made one by one, and the absolute value of each difference is taken to obtain the first mean difference DiffLowerMean, DiffLowerMean=[l₁,l₂,l₃ . . . ,lᵢ . . . ,l_{N}]. The difference between each of the detection data of the N samples that are arranged in sequence and the second mean Meanᵤ are made one by one, and the absolute value of each difference is taken to obtain the second mean difference DiffUpperMean, DiffUpperMean=[u₁,u₂,u₃ . . . , uᵢ . . . ,u_{N}]. Each element in the first mean difference and a respective element in the second mean difference are compared one by one, and the number k of which lᵢ is less than uᵢ(lᵢ<uᵢ) is determined, where i=1,2,3, . . . , N. The reference focus index is updated to k, and in the detection data of the N samples arranged in sequence, the reference focus value is updated to the value of the k-th detection data. In the step c, the step a and the step b are repeated until the value of the reference focus index does not change before and after the update, and in the detection data of the N samples arranged in sequence, the second focus threshold is determined based on the detection data corresponding to the reference focus index.

In some other embodiments, the focus threshold includes the first focus threshold(s), and the number of first focus thresholds is one or more. The obtaining module 141 is further used to receive the user's setting operation of the first focus threshold(s). The display module 142 is further used to display the mark(s) of the first focus threshold(s) in the sample distribution diagram on the graphical interface, and distinguish the data display effects of the positive and negative samples based on the first focus threshold(s).

In some examples, the first focus threshold(s) includes the first value. The display module 142 is used to distinguish the data display effects of the positive and negative samples based on the relationship between the magnitudes of the detection data of the samples and the magnitude of the first value.

In some other examples, the first focus threshold(s) includes the second value and the third value, and the second value is less than the third value. The display module 142 is further used to distinguish the data display effects of the positive and negative samples based on whether the detection data of the sample is greater than the second value and less than the third value.

In some other embodiments, the screening module 144 is used to screen the sample data based on the user's filtering operation of the filtering threshold(s). The display module 142 is further used to display the distribution diagram of the screened samples on the graphical interface.

The filtering threshold(s) includes at least one of the abnormal ratio threshold, the arrival ratio threshold, the production equipment threshold, the environmental parameter threshold, the detection time threshold or the generation time threshold. The sample includes the plurality of sub-samples. The abnormal ratio is used to indicate the proportion of the number of abnormal sub-samples in each sample to the total number of sub-samples included in the sample. The arrival ratio is used to indicate the proportion of the number of sub-samples actually detected in each sample to the total number of sub-samples included in the sample.

Optionally, the filtering operation includes the setting operation or the selecting operation.

Of course, the data processing apparatus 140 provided in the embodiments of the present disclosure includes but is not limited to the above modules.

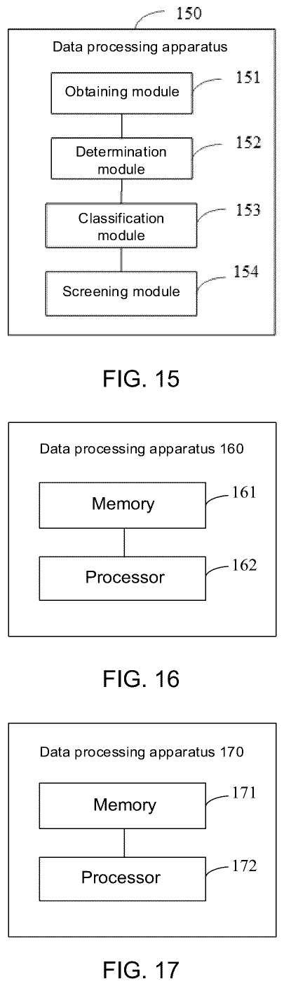

The embodiments of the present disclosure further provide another data processing apparatus. FIG. 15 is a structural diagram of the data processing apparatus 150 provided in the embodiments of the present disclosure. The data processing apparatus 150 is used to perform the data processing method as described in any of the above embodiments. The data processing apparatus 150 may include an obtaining module 151, a determination module 152, a classification module 153 and a screening module 154.

The obtaining module 151 is used to obtain the sample data. The sample data includes the characteristic data and the detection data of the samples. The determination module 152 is used to determine the focus threshold based on the detection data of the samples. The classification module 153 is used to classify the samples into the positive and negative samples based on the focus threshold determined by the determination module 152. The determination module 152 is further used to determine the cause of abnormality of the samples based on the positive and negative samples.

Optionally, the characteristic data of the samples includes at least one of the product model, the detection site, the abnormal type, the arrival ratio, the production equipment, the environmental parameter, the detection time or the generation time.

Optionally, the detection data of the samples includes at least one of the abnormal ratio or the measurement parameter.

In some embodiments, the focus threshold includes the second focus threshold, and the number of samples is N. The determination module 152 is used to: arrange the detection data of the N samples in the ascending order; use the median or the mean of the detection data of the N samples as the reference focus value; and determine the second focus threshold based on the reference focus value and the detection data of the N samples.

In some other embodiments, the determination module 152 is further used to perform the following steps (i.e., the steps a to c). In the step a, detection data, less than or equal to the reference focus value, of the detection data of the N samples is averaged to obtain the first mean Meanₗ; and detection data, greater than the reference focus value, of the detection data of the N samples is averaged to obtain the second mean Meanᵤ. In the step b, the difference between each of the detection data of the N samples that are arranged in sequence and the first mean Meanₗ are made one by one, and the absolute value of each difference is taken to obtain the first mean difference DiffLowerMean, DiffLowerMean=[l₁,l₂,l₃ . . . ,lᵢ . . . ,l_{N}]. The difference between each of the detection data of the N samples that are arranged in sequence and the second mean Meanᵤ are made one by one, and the absolute value of each difference is taken to obtain the second mean difference DiffUpperMean. DiffUpperMean=[u₁,u₂,u₃ . . . ,uᵢ . . . ,u_{N}]. Each element in the first mean difference and a respective element in the second mean difference are compared one by one, and the number k of which lᵢ is less than uᵢ(lᵢ<uᵢ) is determined, where i=1,2,3, . . . , N. The reference focus index is updated to k, and in the detection data of the N samples arranged in sequence, the reference focus value is updated to the value of the k-th detection data. In the step c, the step a and the step b are repeated until the value of the reference focus index does not change before and after the update, and in the detection data of the N samples arranged in sequence, the second focus threshold is determined based on the detection data corresponding to the reference focus index.

In some other embodiments, the screening module 154 is used to screen the sample data based on the filtering threshold(s). The filtering threshold(s) includes at least one of the abnormal ratio threshold, the arrival ratio threshold, the production equipment threshold, the environmental parameter threshold, the detection time threshold or the generation time threshold. The sample includes the plurality of sub-samples. The abnormal ratio is used to indicate the proportion of the number of abnormal sub-samples in each sample to the total number of sub-samples included in the sample. The arrival ratio is used to indicate the proportion of the number of sub-samples actually detected in each sample to the total number of sub-samples included in the sample.

Some other embodiments of the present disclosure further provide a data processing apparatus. As shown in FIG. 16, the data processing apparatus 160 includes a memory 161 and a processor 162. The memory 161 is coupled to the processor 162. The memory 161 is used to store computer program codes, the computer program codes including computer instructions. The processor 162, when executing the computer instructions, causes the data processing apparatus 160 to perform the steps performed by the data processing apparatus in the method flow illustrated by the method embodiments described above.

In actual implementations, the obtaining module 141, the display module 142, the determination module 143 and the screening module 144 may be implemented by the processor 162 shown in FIG. 16 calling the computer program codes in the memory 161. As for a specific implementation process of the above modules, reference may be made to the description of the data processing method shown in FIGS. 2, 3 and 7, which will not be described in detail here.

Some other embodiments of the present disclosure further provide a data processing apparatus. As shown in FIG. 17, the data processing apparatus 170 includes a memory 171 and a processor 172. The memory 171 is coupled to the processor 172. The memory 171 is used to store computer program codes, the computer program codes including computer instructions. The processor 172, when executing the computer instructions, causes the data processing apparatus 170 to perform the steps performed by the data processing apparatus in the method flow illustrated by the method embodiments described above.

In actual implementations, the obtaining module 151, the determination module 152, the classification module 153 and the screening module 154 may be implemented by the processor 172 shown in FIG. 17 calling the computer program codes in the memory 171. As for a specific implementation process of the above modules, reference may be made to the description of the data processing method shown in FIGS. 11, 12 and 13, which will not be described in detail here.

Some embodiments of the present disclosure provide a computer-readable storage medium (e.g., a non-transitory computer-readable storage medium). The computer-readable storage medium has stored thereon computer program instructions. When run on a processor, the computer program instructions cause the processor to perform one or more steps of the data processing method as described in any of the above embodiments.

For example, the computer-readable storage medium may include, but is not limited to, a magnetic storage device (e.g., a hard disk, a floppy disk or a magnetic tape), an optical disk (e.g., a compact disk (CD), or a digital versatile disk (DVD)), a smart card, or a flash memory device (e.g., an erasable programmable read-only memory (EPROM), a card, a stick or a key driver). Various computer-readable storage media described in the embodiments of the present disclosure may represent one or more devices and/or other machine-readable storage media for storing information. The term “machine-readable storage media” may include, but is not limited to, wireless channels and various other media capable of storing, containing and/or carrying instructions and/or data.

Some embodiments of the present disclosure further provide a computer program product. The computer program product includes computer program instructions. When executed on a computer, the computer program instructions cause the computer to perform one or more steps of the data processing method as described in the above embodiments.

Some embodiments of the present disclosure further provide a computer program. When executed on a computer, the computer program causes the computer to perform one or more steps of the data processing method as described in the above embodiments.

Beneficial effects of the computer-readable storage medium, the computer program product and the computer program are the same as beneficial effects of the data processing method as described in some of the above embodiments, which will not be described in detail here.

The foregoing descriptions are merely specific implementations of the present disclosure, but the protection scope of the present disclosure is not limited thereto. Any changes or replacements that a person skilled in the art could conceive of within the technical scope of the present disclosure shall be included in the protection scope of the present disclosure. Therefore, the protection scope of the present disclosure shall be subject to the protection scope of the claims.

1. A data processing method, comprising:
obtaining sample data in response to a user's input operation on a graphical interface, the sample data including characteristic data and detection data of samples;
displaying a sample distribution diagram on the graphical interface based on the sample data;
obtaining a focus threshold used for classifying positive and negative samples; wherein the focus threshold is determined based on the detection data of the samples;
displaying a mark of the focus threshold in the sample distribution diagram on the graphical interface;
distinguishing data display effects of the positive and negative samples based on the focus threshold; and
determining a cause of abnormality of the samples based on the positive and negative samples.

2. The method according to claim 1, wherein the focus threshold includes at least one first focus threshold; and obtaining the focus threshold used for classifying the positive and negative samples, displaying the mark of the focus threshold in the sample distribution diagram on the graphical interface, and distinguishing the data display effects of the positive and negative samples based on the focus threshold, includes:
receiving a user's setting operation of the at least one first focus threshold; displaying at least one mark of the at least one first focus threshold in the sample distribution diagram on the graphical interface; and
distinguishing the data display effects of the positive and negative samples based on the at least one first focus threshold.

3. The method according to claim 2, wherein the at least one first focus threshold includes a first value; and distinguishing the data display effects of the positive and negative samples based on the at least one first focus threshold, includes: distinguishing the data display effects of the positive and negative samples based on a relationship between magnitudes of the detection data of the samples and a magnitude of the first value; or
the at least one first focus threshold includes a second value and a third value, and the second value is less than the third value; and distinguishing the data display effects of the positive and negative samples based on the at least one first focus threshold, includes: distinguishing the data display effects of the positive and negative samples based on whether detection data of a sample in the samples is greater than the second values and less than the third value.

4. (canceled)

5. The method according to claim 1, further comprising:
screening the sample data based on a user's filtering operation of at least one filtering threshold; and
displaying a distribution diagram of screened samples on the graphical interface.

6. The method according to claim 5, wherein the at least one filtering threshold includes at least one of an abnormal ratio threshold, an arrival ratio threshold, a production equipment threshold, an environmental parameter threshold, a detection time threshold or a generation time threshold; and/or
the filtering operation include a setting operation or a selecting operation.

7. (canceled)

8. The method according to claim 1, wherein the characteristic data of the samples includes at least one of a product model, a detection site, an abnormal type, an arrival ratio, a production equipment, an environmental parameter, detection time or generation time; the samples each include a plurality of sub-samples; the arrival ratio is used to indicate a proportion of a number of sub-samples actually detected in each sample to the total number of sub-samples included in the sample; and/or
the detection data of the samples includes at least one of an abnormal ratio of a measurement parameter, the samples each include the plurality of sub-samples, the abnormal ratio is used to indicate a proportion of a number of abnormal sub-samples in each sample to a total number of sub-samples included in the sample.

9. (canceled)

10. The method according to claim 1, wherein the focus threshold includes a second focus threshold, and a number of the samples is N; and obtaining the focus threshold used for classifying the positive and negative samples, displaying the mark of the focus threshold in the sample distribution diagram on the graphical interface, and distinguishing the data display effects of the positive and negative samples based on the focus threshold, includes:
arranging detection data of N samples in an ascending order;
using a median or a mean of the detection data of the N samples as a reference focus value;
determining the second focus threshold based on the reference focus value and the detection data of the N samples; and
displaying a mark of the second focus threshold in the sample distribution diagram on the graphical interface; and
distinguishing the data display effects of the positive and negative samples based on the second focus threshold.

11. The method according to claim 10, wherein determining the second focus threshold based on the reference focus value and the detection data of the N samples includes:
in step a, averaging detection data, less than or equal to the reference focus value, of the detection data of the N samples to obtain a first mean; and averaging detection data, greater than the reference focus value, of the detection data of the N samples to obtain a second mean;
in step b, making a difference between each of the detection data of the N samples that are arranged in sequence and the first mean one by one, and taking an absolute value of each difference to obtain a first mean difference DiffLowerMean, DiffLowerMean=[l₁,l₂,l₃ . . . ,lᵢ . . . ,i_{N}]; making a difference between each of the detection data of the N samples that are arranged in sequence and the second mean one by one, and taking an absolute value of each difference to obtain a second mean difference DiffUpperMean, DiffUpperMean=[u₁,u₂,u₃ . . . ,uᵢ . . . ,u_{N}]; comparing each element in the first mean difference and a respective element in the second mean difference one by one, and determining a number k of which lᵢ is less than uᵢ(lᵢ<uᵢ), where i=1,2,3, . . . ,N; and updating a reference focus index to k, and updating the reference focus value to a value of k-th detection data in the detection data of the N samples arranged in sequence; and
in step c, repeating the step a and the step b until a value of the reference focus index does not change before and after an update; and determining the second focus threshold based on detection data corresponding to the reference focus index in the detection data of the N samples arranged in sequence.

12. A data processing method, comprising:
obtaining sample data, the sample data including characteristic data and detection data of samples;
determining a focus threshold based on the detection data of the samples;
classifying the samples into positive and negative samples based on the focus threshold; and
determining a cause of abnormality of the samples based on the positive and negative samples.

13. The method according to claim 12, wherein the focus threshold includes a second focus threshold, and a number of samples is N; and determining the focus threshold based on the detection data of the samples includes:
arranging detection data of N samples in an ascending order;
using a median or a mean of the detection data of the N samples as a reference focus value; and
determining the second focus threshold based on the reference focus value and the detection data of the N samples.

14. The method according to claim 13, wherein determining the second focus threshold based on the reference focus value and the detection data of the N samples includes:
in step a, averaging detection data, less than or equal to the reference focus value, of the detection data of the N samples to obtain a first mean; and averaging detection data, greater than the reference focus value, of the detection data of the N samples to obtain a second mean;
in step b, making a difference between each of the detection data of the N samples that are arranged in sequence and the first mean one by one, and taking an absolute value of each difference to obtain a first mean difference DiffLowerMean, DiffLowerMean=[l₁,l₂,l₃ . . . ,lᵢ . . . ,l_{N}]; making a difference between each of the detection data of the N samples that are arranged in sequence and the second mean one by one, and taking an absolute value of each difference to obtain a second mean difference DiffUpperMean, DiffUpperMean=[u₁,u₂,u₃ . . . ,uᵢ . . . ,u_{N}]; comparing each element in the first mean difference and a respective element in the second mean difference one by one, and determining a number k of which lᵢ is less than uᵢ(lᵢ<uᵢ), where i=1,2,3, . . . , N; and updating a reference focus index to k, and updating the reference focus value to a value of k-th detection data in the detection data of the N samples arranged in sequence; and
in step c, repeating the step a and the step b until a value of the reference focus index does not change before and after an update; and determining the second focus threshold based on detection data corresponding to the reference focus index in the detection data of the N samples arranged in sequence.

15. The method according to claim 12, further comprising:
screening the sample data based on at least one filtering threshold.

16. The method according to claim 15, wherein the at least one filtering threshold includes at least one of an abnormal ratio threshold, an arrival ratio threshold, a production equipment threshold, an environmental parameter threshold, a detection time threshold or a generation time threshold.

17. The method according to claim 12, wherein the characteristic data of the samples includes at least one of a product model, a detection site, an abnormal type, an arrival ratio, a production equipment, an environmental parameter, detection time or generation time: the samples each include a plurality of sub-samples; the arrival ratio is used to indicate a proportion of a number of sub-samples actually detected in each sample to the total number of sub-samples included in the sample; and/or
the detection data of the samples includes at least one of an abnormal ratio of a measurement parameter; the samples each include the plurality of sub-samples; the abnormal ratio is used to indicate a proportion of a number of abnormal sub-samples in each sample to a total number of sub-samples included in the sample.

18-36. (canceled)

37. A data processing apparatus, comprising a memory and a processor; the memory being coupled to the processor; the memory being used to store computer program codes, and the computer program codes including computer instructions;
wherein when executing the computer instructions, the processor causes the data processing apparatus to perform the data processing method according to claim 1.

38. A non-transitory computer-readable storage medium having stored thereon computer program instructions, wherein when run on a data processing apparatus, the computer program instructions cause the data processing apparatus to perform the data processing method according to claim 1.

39. A computer program product, comprising computer program instructions, wherein when executed on a data processing apparatus, the computer program instructions causes the data processing apparatus to perform the data processing method according to claim 1.

40. A data processing apparatus, comprising a memory and a processor; the memory being coupled to the processor; the memory being used to store computer program codes, and the computer program codes including computer instructions;
wherein when executing the computer instructions, the processor causes the data processing apparatus to perform the data processing method according to claim 12.

41. A non-transitory computer-readable storage medium having stored thereon computer program instructions, wherein when run on a data processing apparatus, the computer program instructions cause the data processing apparatus to perform the data processing method according to claim 12.

42. A computer program product, comprising a computer program instructions, wherein when executed on a data processing apparatus, the computer program instructions cause the data processing apparatus to perform the data processing method according to claim 12.
